(19) United States
(12) Patent Application Publication
(10) Pub. No.: US 2021/0060619 A1
(43) Pub. Date: Mar. 4, 2021

(54) WIND CLASSIFIER

(71) Applicant: BMH Technology Oy, Rauma (FI)

(72) Inventors: Matti KYTÖLÄ, Rauma (FI); Yrjö ROMPPAINEN, Rauma (FI)

(21) Appl. No.: 16/961,027

(22) PCT Filed: Jan. 9, 2019
(86) PCT No.: PCT/FI2019/050011

§ 371 Date: Jul. 9, 2020

(30) Foreign Application Priority Data
Jan. 10, 2018 (FI) 20185026

(51) Int. Cl. B07B 11/06; B07B 13/00; B07B 4/06; B07B 9/00

(52) U.S. Cl. CPC B07B 11/06; B07B 9/00; B07B 4/06; B07B 13/003

(57) ABSTRACT

The invention relates to a wind classifier for classifying material (M), the wind classifier comprising a feed conveyor (2) for carrying the material (M) to be classified; a classifier drum (3) for receiving the material (M) supplied by the feed conveyor (2) and for classifying it on a surface of the classifier drum (3) onto its front side and rear side; blower nozzles (4) positioned between the feed conveyor (2) and classification drum (3) to blow air from substantially below the feed conveyor (2) obliquely upwards over the classification drum (3); and means (7, 8, 9) for adjusting the height and distance of the front end (2b) of the feed conveyor (2) in relation to the classifier dmm (3); whereby the means for adjusting the height and distance of the front end (2b) of the feed conveyor (2) in relation to the classifier dmm (3) comprise a horizontal sliding support (7) of the rear end (2a) of the feed conveyor; a sliding support (8) of the front end (2b) of the feed conveyor (2) substantially obliquely upwards in relation to the classifier dmm (3); and an actuator (9) connected to the feed conveyor (2) for simultaneous moving of the feed conveyor (2) in the direction of said supports (7,8).

### BACKGROUND OF THE INVENTION

The invention relates to a wind classifier for material classification, the wind classifier comprising a feed conveyor for carrying the material to be classified, the feed conveyor having a rear end receiving the material and a front end delivering the material; a classifier drum which is opposite the front end of the feed conveyor for receiving the material supplied by the feed conveyor and for classifying it on a surface of the classifier drum onto the front side and rear side of the classifier drum; blower nozzles placed between the feed conveyor and classifier drum to blow air from substantially below the feed conveyor obliquely upwards over the classifier drum; and means for adjusting the height and distance of the front end of the feed conveyor in relation to the classifier drum.

A wind classifier is one of the most common mass classifier devices, suitable for classifying heavy particles such as stones and metal from a lighter fine fraction. The device is typically used in preparing fuel from household, trade, or industrial waste.

A common device structure includes a feed belt for the materials, a rotating classifier drum, and blower nozzles disposed between the feed belt and classifier drum. The feed belt rotates at such a speed that the material leaving it collides with the classifier drum on a desired sector and together with a contributory air stream causes lighter fractions to pass over the classifier drum whereas the heavy fractions fall between the feed belt and classifier drum.

Depending on the quality and desired classification distribution of the material fed in, the use values of the classifier are adjusted to match any one situation. In a device structure such as the one described, the adjusting elements include, for example, amount and aiming of air, speed of the feed belt, and the distance and height position of the feed belt in relation to the classifier drum. The most important adjusting element may be considered to be the distance and height adjustment of the feed belt.

To adjust the position of the feed belt, such solutions are known where one variable, only, is adjusted, or both variables separately are adjusted. Theoretically, by separately adjusting both variables the most precise adjustment is accomplished, but this method of adjusting is expensive and time consuming, and practise shows that a corresponding benefit is not reached.

From publication U.S. Pat. No. 4,194,633, a wind classifier is known where a conveyor belt feeds unclassified waste or other material mixture to a feed hopper below which there is a second feed conveyor. This second feed conveyor extends inside a horizontally rotating classifier drum. Heavy and light materials are classified within the classifier drum by means of the rotation of the drum and by an air stream produced by a blower installed at one end of the arrangement. The second feed conveyor has an axial, lateral, and vertical adjustment in relation to the classifier drum axis. In this case, the second feed conveyor feeds mixed waste material to the position of the drum where the selected ratio for classifying heavy and light materials is achieved, without the need to change the inclination angle of the classifier drum or the speed of the air stream. The option to adjust the second feed belt makes it possible to feed the material in the optimum location of the classifier drum depending on which material, light or heavy, is dominating.

Publication U.S. Pat. No. 3,957,630 discloses a wind classifier where the angle of inclination of the classifier drum is adjusted to change the speed of air flowing through it. In this case, the feed hopper located on the same platform with the classifier drum moves on an arch-shaped path up and down. The feed belt feeds material in the hopper, and between the feed belt and hopper there is installed a separate, short belt portion to ensure suitable feed into the hopper. One end of the short belt portion is rotatably mounted to a support. For the adjustment arrangement of the front end of the short belt portion, there are spindles fixed to a triangular hanger. Rollers or wheels are rotatably mounted at the corners of the hanger, which move on tracks fixed to the sides of the hopper.

### SUMMARY OF THE INVENTION

An object of the invention is to improve the wind classifier described in the above in such a manner that the aforementioned problems are solved. This object is achieved by means of the inventive wind classifier which is characterised in that the means for adjusting the height and distance of the front end of the feed conveyor in relation to the classifier drum comprise a horizontal sliding support of the rear end of the feed conveyor to enable moving the rear end of the feed belt in the horizontal direction; a sliding support of the front end of the feed conveyor substantially obliquely upwards in relation to the classifier drum to enable moving the front end of the feed conveyor substantially obliquely upwards in relation to the classifier drum; and an actuator connected to the feed conveyor for simultaneous moving of the feed conveyor in the direction of said supports.

So, the invention is based on combining the different adjustments of the wind classifier, achieving an adjustment that is fast, economical, and precise enough for practical conditions. The invention is specifically based on the simultaneous height and distance adjustment of the front end of the feed conveyor in relation to the classifier drum and by means of the same actuator, whereby the rear end of the feed conveyor only moves horizontally at the same time.

Preferred embodiments of the invention are disclosed in the dependent claims.

### LIST OF FIGURES

The invention is now described in closer detail by means of preferred embodiments and with reference to the accompanying drawings, in which:

FIG. 1 is a schematic side view of a preferred embodiment of the wind classifier of the invention; and

FIG. 2 is a schematic side view of a second preferred embodiment of the wind classifier of the invention.

### DETAILED DESCRIPTION OF THE INVENTION

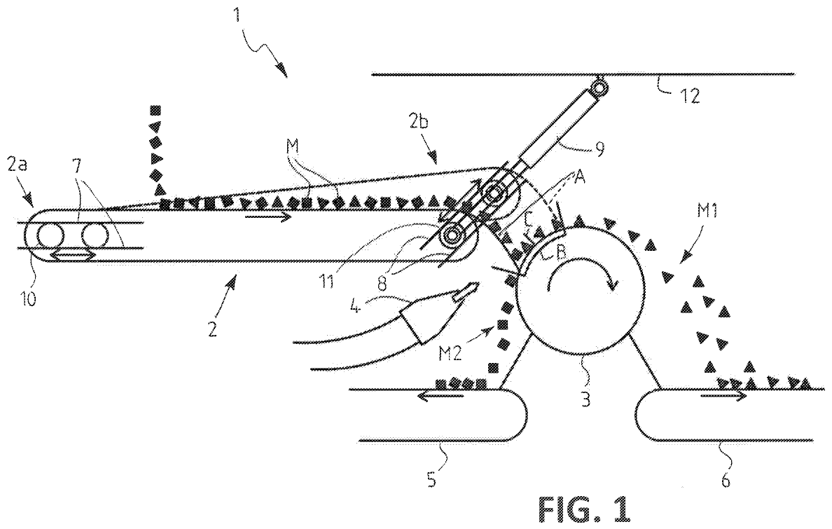

Referring to FIG. 1, the wind classifier 1 according to the invention comprises a feed conveyor 2 for carrying the material M to be classified, such as energy waste, the feed conveyor 2 having a rear end 2a receiving the material and a front end 2b delivering the material; a classifier drum 3 which is opposite the front end 2b of the feed conveyor 2 for receiving the material M supplied by the feed conveyor 2 and for classifying it on a surface of the classifier drum 3 onto the front side and rear side of the classifier drum 3; blower nozzles 4 placed between the feed conveyor 2 and classifier drum 3 to blow air from substantially below the feed conveyor 2 obliquely upwards over the classifier drum 3; and means for adjusting the height and distance of the front end 2b of the feed conveyor 2 in relation to the classifier drum 3. Furthermore, below the classifier drum 3 there are arranged conveyors 5 and 6 to remove the classified material fractions M1 and M2 from the wind classifier 1. The feed conveyor 2 and conveyors 5 and 6 are typically belt conveyors.

The means for adjusting the height and distance of the front end 2b of the feed conveyor 2 in relation to the classifier drum 3 comprise a horizontal sliding support 7 of the rear end 2a of the feed belt 2 to enable moving the rear end 2a of the feed belt 2 in the horizontal direction; a sliding support 8 of the front end 2b of the feed conveyor 2 substantially obliquely upwards in relation to the classifier drum 3 to enable moving the front end 2b of the feed conveyor 2 substantially obliquely upwards in relation to the classifier drum 3; and an actuator 9 connected to the feed conveyor 2 for simultaneous moving of the feed conveyor 2 in the direction of said supports 7 and 8.

The sliding support of the rear end 2a of the feed conveyor 2 comprises slide supports 7 of the rear end 2a of the feed conveyor 2 on both sides of the feed conveyor 2 so that a belt drum 10 of the rear end 2a is able to slide along these slide guides 7; and the sliding support of the front end 2b of the feed conveyor 2 comprises slide guides 8 of the front end 2b of the feed conveyor 2 on both sides of the feed conveyor 2 so that a belt drum 11 of the front end 2a is able to slide along these slide guides 8.

Said slide guides 7 and 8 of the rear end 2a and front end 2b of the feed conveyor 2 may be formed of, for example, C profiles or rails on both sides of the feed conveyor 2, at its rear end 2a and front end 2b.

In FIG. 1, the actuator 9, which may advantageously be a hydraulic cylinder, screw jack, or a similar device producing linear movement, is connected obliquely in the direction of the slide guides 6 to the front end 2b of the feed conveyor 2 above the feed conveyor 2, such as to a ceiling 12 of wind classifier premises.

Alternatively, the actuator 9 could be obliquely connected in the direction of the slide guides 8 to the front end 2b of the feed conveyor 2 below the feed conveyor 2. This option is not separately shown in the drawings.

If the actuator 9 is connected rigidly enough to the front end 2b of the feed conveyor 2, it may at the same time constitute the sliding support of the front end 2b of the feed conveyor 2, whereby the slide guides 8 formed of C profiles or rails, mentioned as an example, are not needed. In such a case, the rear end 2a of the feed conveyor 2 is further supported to the aforementioned separate slide guides 7 or the rear end 2a.

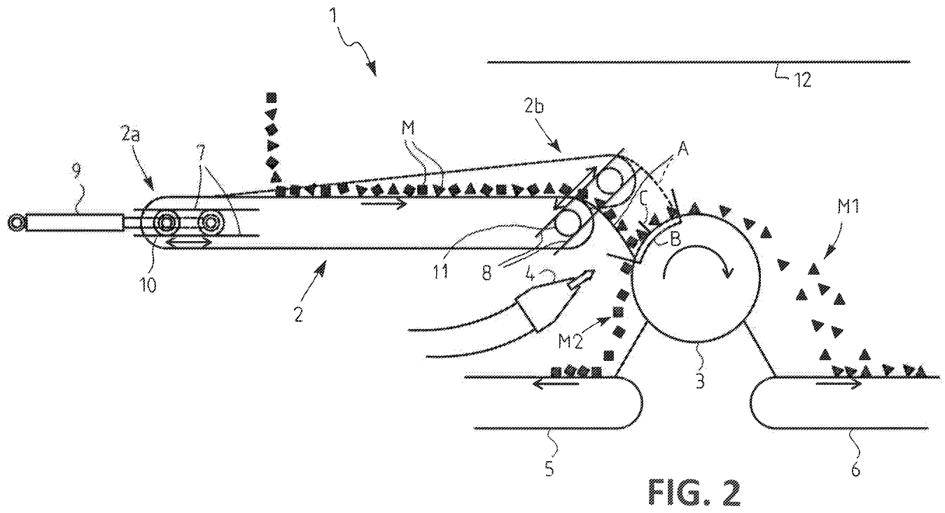

The structure shown in FIG. 2 differs from the structure of FIG. 1 in that the actuator 9 is connected horizontally to the rear end 2a of the feed conveyor 2. In other respects, the elements are the same as those in FIG. 1.

If the actuator 9 in the drawings is connected rigidly enough to the rear end 2b of the feed conveyor 2 (rigidly in the same manner as in the embodiment of FIG. 1), it may at the same time constitute the sliding support of the rear end 2a of the feed conveyor 2, whereby the slide guides 7 formed of C profiles or rails are not needed. The front end 2b of the feed conveyor 2 is in this case further supported to the separate slide guides 8 of the front end 2, which were described in the above.

The sliding support 8 of the front end 2b of the feed conveyor 2 may be a circular arch which is coaxial with the centre point of the classifier drum 3.

The height and distance adjustment of the front end 2b of the feed conveyor 2 in relation to the classifier drum 3 is dependent on at least two of the following group of variables: the particle size of the material M classified, particle size distribution of the material M classified, density of the material M classified, moisture of the material M classified, shape of the particles of the material M classified.

In the wind classifier according to the invention, the material M being classified runs as a thin carpet from the feed conveyor 2 onto the surface of the classifier drum 3 according to the falling curve A. The initial form of the falling curve A is determined by the feed speed of the feed conveyor 2 feeding the material M, in other words, in case of a belt conveyor, the speed of the belt. The air flowing from blower nozzles 4 seeks to straighten this falling curve A even before the material M hits the classifier drum 3. When the front end 2b of the feed conveyor 2 is at the centre position of its adjustment position, the material flow M collides with the classifier drum 3 in substantially the direction of its normal at point C or sector B. From this point, the material flow M on the surface of the classifier drum 3 is classified into two fractions M1 and M2 in a manner characteristic of the material mixture by the effect of blowing air and the rotation of the classifier drum 3, the first of which, Ml, overflies (overflow) the classifier drum 3 and falls on a transfer belt 6 on the front side of the classifier drum 3, and the second of which, M2, goes under (underflow) the classifier drum and falls on a transfer belt 5 at the rear of the classifier drum 3. To simplify the situation applicably, the physical factor classifying the different pieces of the material mixture is the ratio between the force caused by the flow to the piece and the weight of the piece. Based on this power ratio, the direction of acceleration conducted to the piece determines the piece to be carried either to the overflow or underflow. If it is desired to shift the intersection of the classification on the basis of the ever-changing material mixture being classified, placing emphasis on the appearance of certain kind of pieces in the fractions formed, it may be carried out by affecting said power ratio. A possible method to affect the power ratio is to adjust the intersecting point of the falling curve A and the surface of the classifier drum 3 on sector B. When the height of the intersecting point on sector B is raised, the support force conveyed by the classifier drum 3 begins to progressively cancel the amount of the free weight of the piece compared to the force conducted on the piece by the air flow. An opposite situations is achieved by bringing the intersecting point downwards. This adjustment may be accomplished with the structure disclosed in the above in an advantageous and managed manner with one single actuator 9 by shifting the front end of the feed belt on the travel paths described.

The above description of the invention is only intended to illustrate the basic idea of the invention. A person skilled in the art may, however, implement its details within the scope of the attached claims.

1. A wind classifier for classifying material, the wind classifier comprising
a feed conveyor for carrying the material to be classified, the feed conveyor having a rear end receiving the material and a front end delivering the material;
a classifier drum which is opposite the front end of the feed conveyor for receiving the material supplied by the feed conveyor and for classifying it on a surface of the classifier drum onto the front side and rear side of the classifier drum
blower nozzles positioned between the feed conveyor and classification drum to blow air from substantially below the feed conveyor obliquely upwards over the classification drum:
and means for adjusting the height and distance of the front end of the feed conveyor in relation to the classifier drum,
wherein the means for adjusting the height and distance of the front end of the feed conveyor in relation to the classifier drum comprise a horizontal sliding support of the rear end of the feed conveyor to enable moving the rear end of the feed conveyor in the horizontal direction; a sliding support of the front end of the feed conveyor substantially obliquely upwards in relation to the classifier drum to enable moving the front end of the feed conveyor substantially obliquely upwards in relation to the classifier drum; and an actuator connected to the feed conveyor for simultaneous moving of the feed conveyor in the direction of said supports.

2. A wind classifier as claimed in claim 1, wherein the sliding support of the rear end of the feed conveyor comprises slide supports of the rear end of the feed conveyor; and in that the sliding support of the front end of the feed conveyor comprises slide guides of the front end of the feed conveyor.

3. A wind classifier as claimed in claim 2, wherein the slide guides of the rear end and front end of the feed conveyor comprise C profiles on both sides of the feed conveyor, at its rear end and front end.

4. A wind classifier as claimed in claim 2, wherein the actuator is connected to the front end of the feed conveyor above the feed conveyor.

5. A wind classifier as claimed in claim 4, wherein the actuator is suspended from the ceiling of the wind classifier premises.

6. A wind classifier as claimed in claim 2, wherein the actuator is connected to the front end of the feed conveyor below the feed conveyor.

7. A wind classifier as claimed in claim 2, wherein the actuator is connected horizontally to the rear end of the feed conveyor.

8. A wind classifier as claimed in claim 1, wherein the actuator is connected rigidly to the front end of the feed conveyor, whereby it at the same time constitutes the sliding support of the front end of the feed conveyor, while the rear end of the feed conveyor is supported to separate slide guides of the rear end.

9. A wind classifier as claimed in claim 1, wherein the actuator is connected rigidly to the rear end of the feed conveyor, whereby it at the same time constitutes the sliding support of the rear end of the feed conveyor, while the front end of the feed conveyor is supported to separate slide guides of the front end.

10. A wind classifier as claimed in claim 8, wherein the separate slide guides comprise C profiles on both sides of the feed conveyor.

11. A wind classifier as claimed in claim 1, wherein the feed conveyor is a belt conveyor.

12. A wind classifier as claimed in claim 1, wherein the sliding support of the front end of the feed conveyor is a circular arch which is coaxial with the centre point of the classifier drum.

13. A wind classifier as claimed in claim 1, wherein the actuator is a hydraulic cylinder, screw jack, or a similar device producing linear movement.

14. A wind classifier as claimed in claim 1, wherein it additionally comprises conveyors below the classifier drum to remove the classified material fractions from the wind classifier.

15. A wind classifier as claimed in claim 1, wherein the height and distance adjustment of the front end of the feed conveyor in relation to the classifier drum is dependent on at least two of the following group of variables: the particle size of the material classified, particle size distribution of the material classified, density of the material classified, moisture of the material classified, shape of the particles of the material classified.
